(19) United States
(12) Patent Application Publication
(10) Pub. No.: US 2008/0148375 A1
(43) Pub. Date: Jun. 19, 2008

(54) Authentication system, authentication device, and authentication method

(76) Inventors: Yasuhiro Yamamoto, Nagoya (JP); Kazuhisa Yamamura, Owariasahi (JP)

Correspondence Address: MCDERMOTT WILL & EMERY LLP, 600 13TH STREET, N.W., WASHINGTON, DC, 20005-3096, US

(21) Appl. No.: 11/987,127

(22) Filed: Nov. 27, 2007

(30) Foreign Application Priority Data
Nov. 28, 2006 (JP) 2006-319939

(51) Int. Cl. G06F 21/20

(52) U.S. Cl. 726/7

(57) ABSTRACT

An authentication system comprising: a terminal device 100 that includes a biometric information generating portion 160 generating biometric information that does not fluctuate across individual measurements, input unit 172 for inputting a password, specific code generating unit for generating a specific code unique to each combination of the biometric information and the additional information, and communication module 140 for sending the specific code to a server; and a server 200 that includes communication module 240 for receiving the specific code, storage 230 for associating and storing an identifying code and an account, search module for searching for an identifying code matching the specific code, and account specifying module for specifying an account matching the identifying code retrieved by the search module.

The present application claims priority from Japanese application JP2006-319939 filed on Nov. 28, 2006, the content of which is hereby incorporated by reference.

### BACKGROUND OF THE INVENTION

The present invention relates in general to authentication technology employing biometric information, and relates in particular to technology using biometric information for identifying a single account from among a multitude of accounts.

Where accounts are identified from biometric information, acquired biometric information and currently registered registration information must be matched for similarity on a one-to-one basis. A resultant problem is that as the number of registrants increases, the number of match iterations required will increase appreciably. One known technology addressed to this problem involves utilizing identity with others, i.e. the fact that data for other registrants is not entirely different and commonality may be observed in portions of the data, in order to pre-classify registration information into groups with the same general data. When matching is performed, first identifying a group having the same general data then performing matching of the full data within that group, in order to reduce the number of match iterations required. Another known technology proposes the use of an information conversion key stored on a server, to carry out nonreversible data conversion of biometric information and hide the biometric information.

However, technology that utilizes identity with others has the drawback that unless registration information is classified into groups of general data, it is difficult to decide the group of general data into which information should be classified. Moreover, during matching, it is necessary to use both general data and full data, and thus a considerable amount of information must be matched, possibly putting strain on the database.

### SUMMARY OF THE INVENTION

There are needs for reducing the time required for matching despite very large numbers of data registrations.

To address the above problems, the authentication system pertaining to a first aspect of the present invention provides an authentication system comprising a terminal device and a server. The terminal device comprises a biometric information generating unit configured to acquire biometric characteristics and generate biometric information; an additional information input module for inputting additional information; a specific code generating module configured to generate a specific code unique to each combination of the biometric information and the additional information using the biometric information and the additional information; and a communication module configured to send the specific code to the server. The server comprises a communication module configured to receive the specific code; a storage that associates and stores an identifying code and an account; a search module configured to search for the identifying code matching the specific code; and an account specifying module configured to specify an account matching the identifying code retrieved by the search module. According to the authentication system pertaining to the first aspect of the present invention, a specific code unique to each combination of the biometric information and the additional information is generated for the combination, and an identifying code matching the specific code is searched for. Since the search simply decides whether the specific code and the identifying code match and does not determine the degree of similarity, searches may be performed within a short time.

In the authentication system pertaining to the first aspect of the present invention, the specific code generating module may generate a specific code using biometric information having identical values, where the biometric information generating module has measured the same measurement subject. According to the authentication system pertaining to the first aspect of the present invention, by using biometric information having the identical values in the event that the biometric information generating unit has measured the same measurement subject, the specific code generating module may generate an identical specific code, provided that the additional information is identical as well. Consequently, during a search, the authentication system only decides whether the specific code and the identifying code match, so searches may be performed within a short time.

In the authentication system pertaining to the first aspect of the present invention, the biometric information generating unit measures the same measurement subject multiple times, and generates biometric information using some of that portion of measurement results having identical values from among the measurement results. According to the authentication system pertaining to the first aspect of the present invention, by using a part of measurement results having identical values from among the measurement results to generate the biometric information, the specific code generating module may generate an identical specific code, provided that the additional information is identical as well. Consequently, during a search, the authentication system only decides whether the specific code and the identifying code match, so searches may be performed within a short time.

In the authentication system pertaining to the first aspect of the present invention, the biometric information generating module measures a measurement subject multiple times while varying the conditions of measurement. According to the authentication system pertaining to the first aspect of the present invention, since the part having identical values despite different conditions of measurement represents the part unlikely to experience variability of measurement results each time that measurements are made, identical biometric information may be generated by utilizing this part.

In the authentication system pertaining to the first aspect of the present invention, the biometric information includes data having undergone irreversible data conversion. According to the authentication system pertaining to the first aspect of the present invention, measurement results per se maybe kept confidential by subjecting measurement results to irreversible data conversion.

In the authentication system pertaining to the first aspect of the present invention, the server further comprises identifying code registering module configured to register the generated specific code as an identifying code. According to the authentication system pertaining to the first aspect of the present invention, identifying codes may be registered easily. Furthermore, since registered identifying codes are associated with specific codes, a system may be configured easily to retrieve registered identifying codes by using specific codes.

In the authentication system pertaining to the first aspect of the present invention, the server further comprises input instructing module configured to instruct the terminal device to input different additional information, in the event that, during registration of an identifying code in an authentication device, an identifying code identical to the generated specific code is already stored in the storage. According to the authentication system pertaining to the first aspect of the present invention, in the event that an identifying code identical to a specific code it is being attempted to register has already been registered, that specific code will not be registered, thus avoiding duplicate registration. Furthermore, in the event that that an identifying code identical to a specific code it is being attempted to register has already been registered, the terminal device will be instructed for input of different additional information. As a result, a specific code different from the already registered identifying code may be generated.

The authentication system pertaining to the first aspect of the present invention is further provided with suggested additional information generating unit configured to generate suggested additional information for use by the specific code generating module to generate a specific code different from the already registered identifying code. According to the authentication system pertaining to the first aspect of the present invention, during registration of a specific code, suggested additional information is generated for the purpose of avoiding generation of a specific code identical to an already registered identifying code. Thus, generation of a specific code identical to an already registered identifying code may be avoided by selecting additional information from among the suggested information.

In the authentication system pertaining to the first aspect of the present invention, the suggested additional information module is provided to the terminal device. According to the authentication system pertaining to the first aspect of the present invention, since the suggested additional information module is provided to the terminal device, it is not required to divide the specific code into biometric information and additional information.

In the authentication system pertaining to the first aspect of the present invention, the suggested additional information module is provided to the server. Since the suggested additional information module is provided to the server, communication for the purpose of executing duplicate checking of an identifying code registered with the server, and a specific code generated from biometric information and additional information, may be minimized.

In the authentication system pertaining to the first aspect of the present invention, the terminal device further comprises second biometric information generating unit configured to generate second biometric information for use as additional information, from biometric characteristics different from the aforementioned biometric characteristics. Typically, since it is virtually impossible for different individuals to be identical as far as this second biometric information, according to the authentication system pertaining to the first aspect of the present invention, duplication of specific codes will be substantially impossible.

The authentication system pertaining to the first aspect of the present invention is further provided with an additional information generating module configured to generate additional information for use by the specific code generating module to generate a specific code that matches the already registered identifying code, in the event that the identifying code has already been registered for a given account. According to the authentication system pertaining to the first aspect of the present invention, in the event that the identifying code has already been registered for a given account and the biometric information is to be modified, additional information for generating a specific code identical to the registered code can be presented together with new biometric information.

In the authentication system pertaining to the first aspect of the present invention, the additional information generating module is provided to the terminal device. According to the authentication system pertaining to the first aspect of the present invention, additional information may be generated easily, by sending an identifying code from the server to the terminal device.

In the authentication system pertaining to the aspect of the present invention, the storage stores multiple identifying codes in association with a single account. According to the authentication system pertaining to the first aspect of the present invention, a single account may be used by multiple individuals.

To address the above problems, the present invention in a second aspect thereof provides an authentication device. The authentication device comprises a biometric information generating unit configured to acquire biometric characteristics and generate biometric information; an additional information input module for inputting additional information; a specific code generating module configured to generate a specific code unique to each combination of the biometric information and the additional information using the biometric information and the additional information; a storage that associates and stores an identifying code and an account; a search module configured to search for the identifying code matching the specific code; and an account specifying module configured to specify an account matching the identifying code retrieved by the search module. According to the authentication device pertaining to the second aspect of the present invention, even in an authentication device not divided into a terminal device and server, it is possible nevertheless to generate a specific code unique to each combination of biometric information and additional information, and to retrieve an identifying code matching the specific code. Since the search simply decides whether the specific code and the identifying code match and does not determine the degree of similarity, searches may be performed within a short time.

To address the above problems, the present invention in a third aspect thereof provides a method of registering to an authentication system. The method of registering to an authentication system pertaining to the third aspect of the present invention comprises taking multiple measurements of a measurement subject and acquiring biometric information; generating biometric information using some of that portion of measurement results having identical values from among the measurement results; generating a unique first specific code using the biometric information and input additional information,; searching for an identifying code matching the specific code, from a storage storing in associated form an identifying code and account; in the event that an identifying code matching the first specific code has not yet been recorded in the storage, registering the first specific code as an identifying code; in the event that an identifying code matching the specific code has already been recorded in the storage, generating suggested additional information for generating a specific code that does not match the identifying code already registered in association with the biometric information; generating a unique second specific code; and registering the second specific code as an identifying code using the additional information and the biometric information. According to the method of registering to an authentication system pertaining to the third aspect, a unique specific code may be generated for each combination of biometric information and the additional information. During registration of the specific code so generated as an identifying code, in the event that the generated specific code is identical to a previously registered identifying code, it will not be recorded, thus avoiding duplicate registration of identifying codes.

To address the above problems, the present invention in a fourth aspect thereof provides an authentication method for an authentication system. The authentication method for an authentication system pertaining to the fourth aspect of the present invention comprises taking multiple measurements of a measurement subject and acquiring biometric information; using a part of measurement results having identical values from among the measurement results to generate biometric information; generating a unique first specific code using the biometric information and input additional information; searching for an identifying code matching the specific code, from a storage storing in associated form an identifying code and account; and in the event that an identifying code matching the specific code is found, identifying the account associated with the identifying code. According to the authentication method for an authentication system pertaining to the fourth aspect of the present invention, it is simply decided whether the specific code and the identifying code match and does not determine the degree of similarity, and thus searches may be performed within a short time.

### BRIEF DESCRIPTION OF THE DRAWINGS

Preferred embodiments of the present invention will now be described in conjunction with the accompanying drawings, in which:

FIG. 1 is an illustration depicting an overview of an authentication system pertaining to the embodiment;

FIG. 2 is an illustration depicting a database file configuration;

FIG. 3 is a flowchart depicting operation of a terminal device during registration (part 1);

FIG. 4 is a flowchart depicting operation of a terminal device during registration (part 2);

FIG. 5 is a flowchart depicting operation of a terminal device during registration (part 3);

FIG. 6 is a password selection window displayed on a display;

FIG. 7 a flowchart depicting operation of a server during registration; and

FIG. 8 is a flowchart depicting operation of a terminal device during authentication.

### DESCRIPTION OF THE PREFERRED EMBODIMENTS

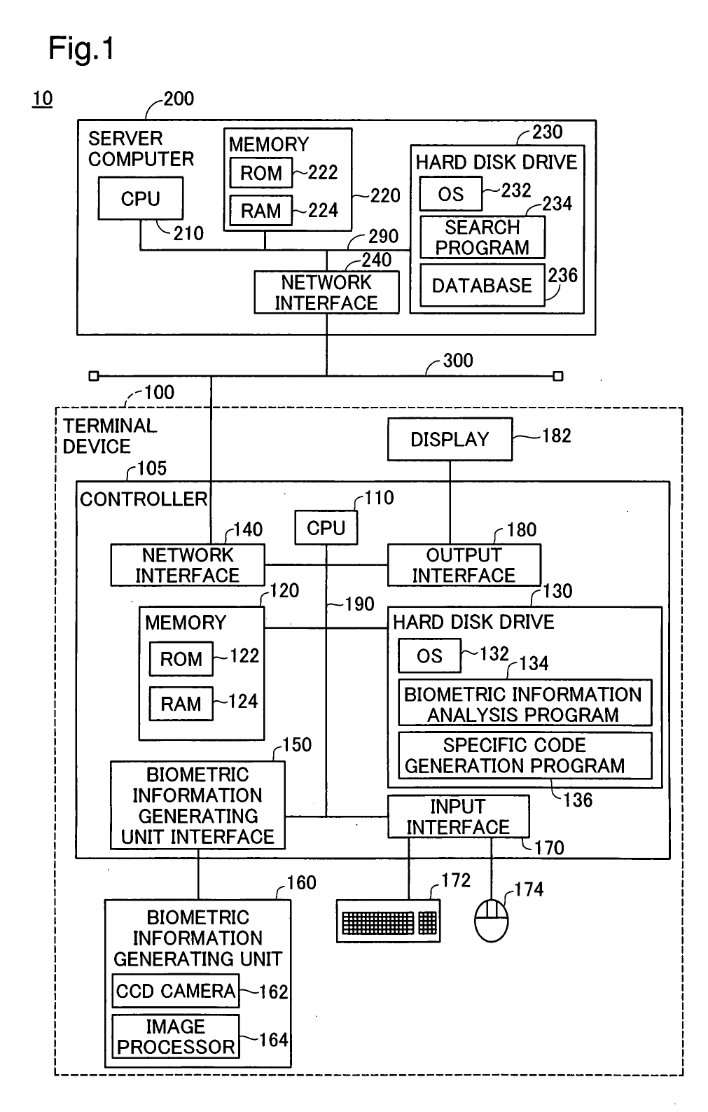

The configuration of the authentication system 10 pertaining to the present embodiment will be described. FIG. 1 is an illustration depicting an overview of the authentication system 10 pertaining to the embodiment. The authentication system 10 comprises a terminal device 100 and a server 200. The terminal device 100 and the server 200 are connected by a network 300.

The terminal device 100 acquires biometric characteristics of a subject for authentication, generates biometric information, and generates a specific code from the biometric information and a password which has been input separately. The terminal device 100 has a controller 105, a biometric information generating portion 160, input devices, namely, a keyboard 172 and a mouse 174, and a display device, namely, a display 182.

The biometric information generating unit 160 measures a measurement subject. The biometric information generating unit 160 includes, for example, a CCD camera 162 and an image processing portion 164. The CCD camera 162 acquires an image of a biometric characteristic, such as a fingerprint, digital vein, retinal blood vessel pattern. The image processing module 164 performs processing to convert the image acquired by the CCD camera 162 to digital data, for example.

The keyboard 172 is an input device for input of passwords and other data, and for input of instructions to the terminal device 100, for example. The mouse 174 is an input device for password selection and for input of instructions to the terminal device 100, for example. The display 182 is a display device for displaying information from the terminal device 100. In the present embodiment, the keyboard 172 and mouse 174 are used as input devices and the display 182 is used as an output device, however a touchscreen display or other device that combines an input device and an output device may be used as well.

The controller 105 has a CPU 110, ROM 122, RAM 124, a hard disk drive 130, a network interface 140, a biometric information generating unit interface 150, an input interface 170, an output interface 180, and a bus 190.

The CPU 110 is the nerve center of the terminal device 100, and controls operations of the terminal device 100 as a whole. Using the biometric characteristic digital data acquired by the biometric information generating unit 160, the CPU 110 generates biometric information. The CPU 110 also generates a specific code from the biometric information and a password input from the keyboard 172.

The ROM 122 is a read-only memory for storing the BIOS (Basic Input Output System) that controls the hard disk drive 130 and peripherals such as the keyboard 172, for example. The RAM 124 is a rewritable volatile memory, the operating system (hereinafter “OS”) of the terminal device 100 and application programs are loaded into the RAM 124 from the hard disk drive 130 and executed on the RAM 124. The RAM 124 also temporarily stores results of computations by the CPU 110, data currently being computed, or data received from the server 200.

The hard disk drive 130 is a storage device for storing the OS 132 and application programs, for example. The OS 132 is the basic program for managing execution of application programs and so on. Application program refers to an application software program such as a biometric information analysis program 134 and a specific code generation program 136, for example. The biometric information analysis program 134 analyzes multiple digital data acquired by the biometric information generating unit 160, and if the digital data includes data measured for the same given measurement subject, determines portions having the same value, for example, from the first bit to the m-th bit, in each individual measurement. Where the digital data includes measurements of the same given subject, the CPU 100 uses the portions having the same value in each individual measurement to generate biometric information The specific code generation program 136 generates a specific code from the biometric information and a password input from the keyboard 172.

The network interface 140 is an interface for connecting the terminal device 100 to the network 300. The biometric information generating unit interface 150 is an interface for connecting the biometric information generating unit 160 to the controller 105. The input interface 170 is an interface for connecting, for example, the keyboard 172 and the mouse 174 to the controller 105. The output interface 180 is an interface for connecting the display 182 to the controller 105.

The bus 190 is a communication path for exchange of data among the CPU 110, the ROM 122, the RAM 124, the hard disk drive 130, the network interface 140, the biometric information generating portion interface 150, the input interface 170, and the output interface 180.

The server 200, using the specific code, searches for a previously registered identifying code, and performs authentication. The server 200 is furnished with a CPU 210, ROM 222, RAM 222, a hard disk drive 230, and a network interface 240.

The CPU 210 is the nerve center of the server 200, and controls operations of the server 200 as a whole. The CPU 210 searches a database file 236 containing as a key a specific code received from the terminal device 100, saved on the hard disk drive 230.

The ROM 222 is a read-only memory for storing the BIOS, for example. The RAM 224 is a rewritable volatile memory, the operating system (hereinafter “OS”) of the server 200 and application programs are loaded into the RAM 224 from the hard disk 230 and executed in the RAM 124. The RAM 224 also temporarily stores results of computations by the CPU 210, data currently being computed, or data received from the terminal device 100.

The hard disk drive 230 is a storage device for storing the OS 232, application programs, and data for example. Application software programs such as a search program 234 are stored as application programs on the hard disk 230. Using a specific code received from the terminal device 100 as the key, the search program 234 searches the database file 236 stored on the hard disk 230, and retrieves an identifying code identical to the specific code. Data refers, for example, to information encoded or digitized so as to be suited to processing by the CPU 202. The database file 236, which contains as data identifying codes and their associated accounts, is stored on the hard disk drive 230.

The network interface 240 is an interface for connecting the server 200 to the network 300. The bus 290 is a communication path for exchange of data among the CPU 210, the memory 220, the hard disk drive 230, and the network interface 240.

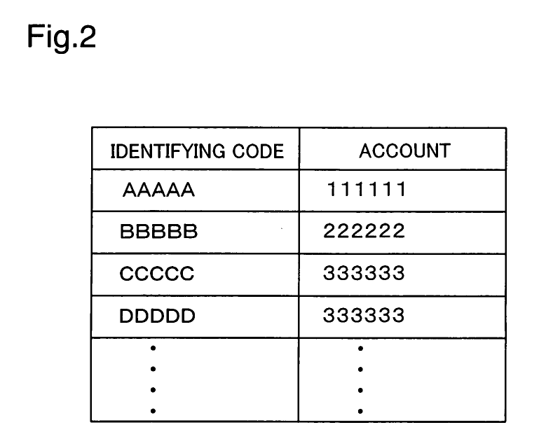

The configuration of the database file 236 will now be described. FIG. 2 is an illustration depicting the database file 236 configuration. As shown in FIG. 2, the database file 236 is configured so that one account is associated with each one identifying code. Thus, once an identifying code has been specified, the corresponding account is determined.

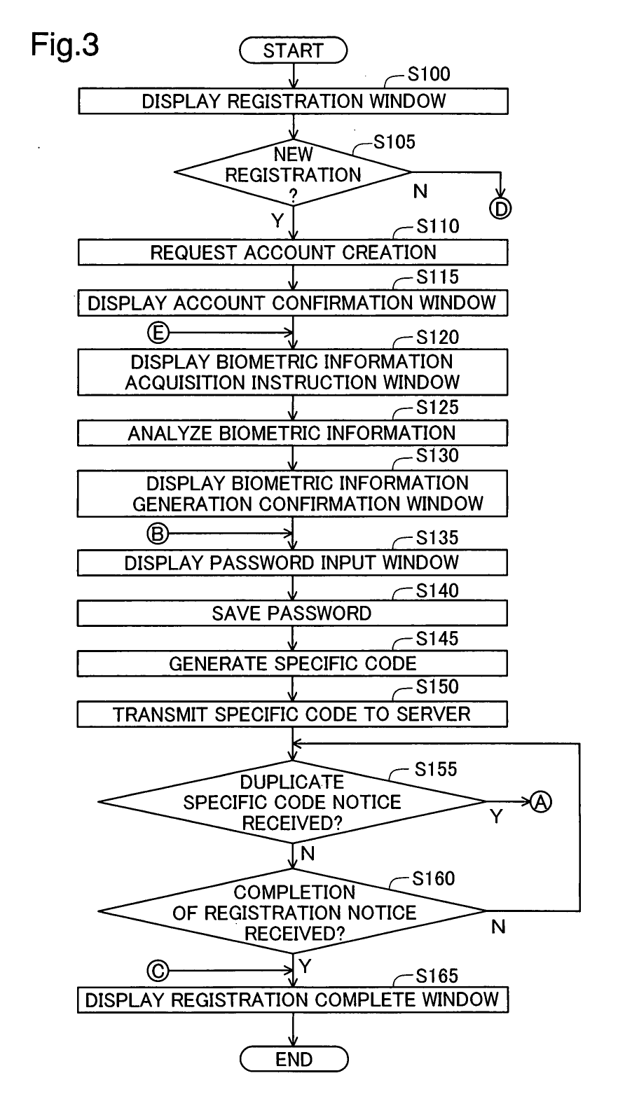

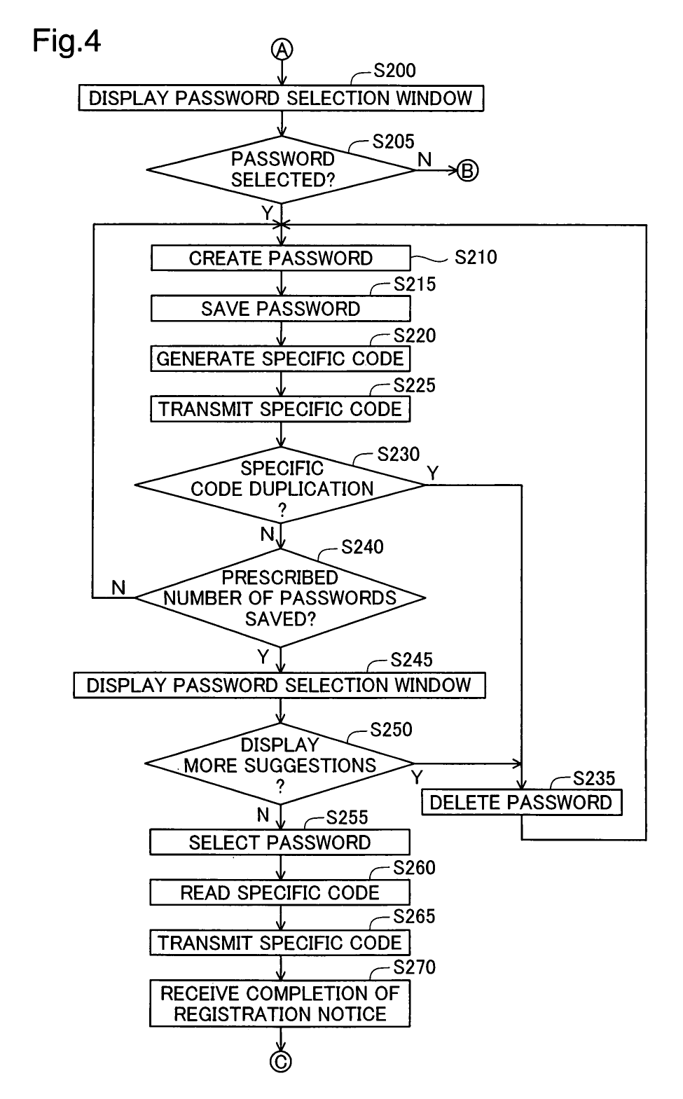

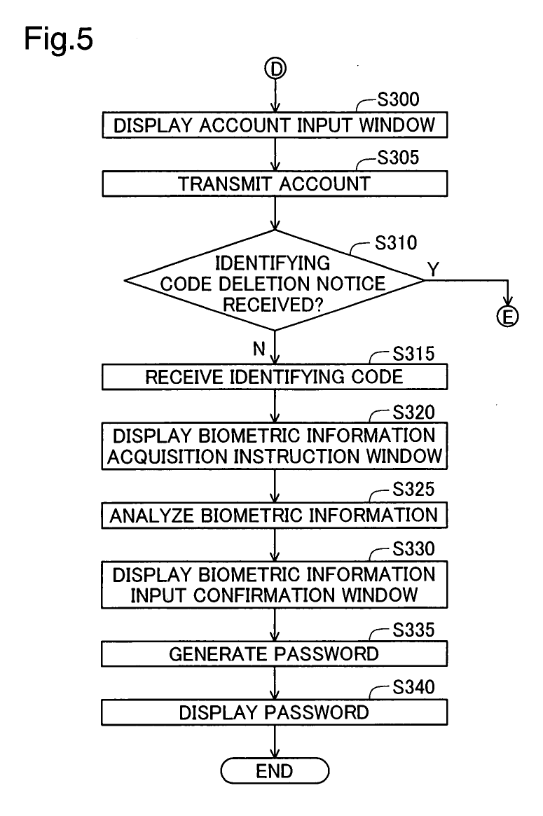

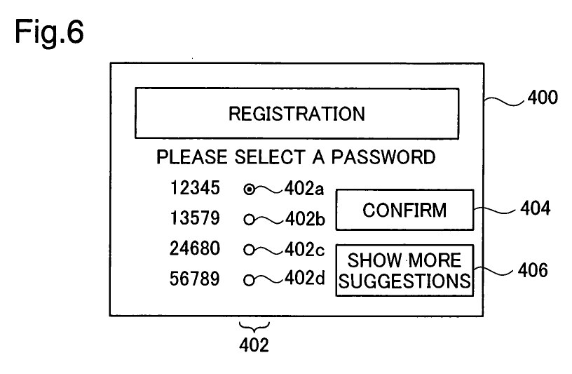

Operations of the terminal device 100 of the authentication system 10 during registration will be discussed with reference to FIGS. 3 through 6. FIG. 3 is a flowchart depicting operation of the terminal device 100 during registration (part 1). FIG. 4 is a flowchart depicting operation of the terminal device 100 during registration (part 2). FIG. 5 is a flowchart depicting operation of the terminal device 100 during registration (part 3). FIG. 6 is a password selection window displayed on the display 182.

Registration and correction of registered content discussed below will be carried out by an administrator who has privileges to carry out registration and correction of registered content.

Where an account is to be registered or where registered content is to be corrected in the authentication system 10, the CPU 110 shows a registration window (not illustrated) on the display 182 (Step S100). The registration window shows a new registration icon, to be selected in the event that a new account is being registered, a registration correction icon to be selected in the event that registered content is being corrected for a previously registered account. The CPU 110 waits for selection of either the new registration icon or the registration correction icon.

If the CPU 110 detects that the new registration icon has been selected (Step S105, Y), the CPU 110 issues an account creation request to the server 200 (Step S110) and waits for the server 200 to send notice that the account has been created. Once the CPU 110 receives notice from the server 200 that the account has been created, an account confirmation window (not illustrated) is displayed on the display 182 (Step S115). An account confirmation icon for notifying the CPU 110 that the account has been verified is displayed in the account confirmation window. The CPU 110 waits for selection of the account confirmation icon.

Once the CPU 110 detects that the account confirmation icon has been selected, the CPU 110 shows on the display 182 a biometric information acquisition instruction window for the purpose of instructing that biometric information be measured (Step S120). The CPU 110 waits for results of measurement of the authentication subject by the biometric information generating portion 160 to be sent to it.

Using the CCD camera 162, the biometric information generating unit 160 takes a picture of a prescribed region of the authentication subject. The resultant picture is processed by the image processing module 164 and converted to digital data of n bits, for example. Typically, taking the example of fingerprint authentication, where the biometric information generating unit 160 measures a prescribed region of the authentication subject, parameters such as the angle of rest of the finger on the measuring portion (not illustrated) or the level of force with which the finger is pressed against the measuring portion will not be identical across individual measurements. As a result, some of the bits of the resultant n-bit digital data will experience fluctuations and poor reproducibility across individual measurements. However, if an appropriate threshold value is set, it will be possible to obtain data with good reproducibility, for the remaining bits. Herein, threshold value refers, for example, to a threshold limit value for the purpose of deciding whether to set each bit to 1 or 0 during conversion from picture data to digital data by the image processing module 164. As threshold values it would be possible to use, for example, accuracy when the image processing module 164 reads coordinates of a feature point such as an edge point or branch point from the picture data. From the n-bit digital data obtained through the use of the prescribed threshold value, the CPU 110 generates biometric information from a portion thereof, for example, from the first bit through the m-th bit (Step S125). The determination is made in the following manner, for example.

The image processing module 164 generates digital data from the picture data, using pre-registered threshold values selected so as to afford identical values from the first bit through the m-th bit, in spite of factors which could give rise to fluctuations in measurement results, such as the angle of rest of the finger on the measuring portion or the level of force with which the finger is pressed against the measuring portion, during measurement of a given measurement subject. Specific threshold values may be derived, for example, through statistical analysis of past measurement results, and registered in the image processing portion 164. The CPU 110 uses the values of first bit through the m-th bit in the digital data to generate the biometric information. As a result, identical biometric information may be generated repeatedly from the same given measurement subject.

The CPU 110 may also generate biometric information in the following manner. The biometric information generating unit 160 carries out measurement multiple times, while varying the measurement conditions, e.g. the threshold values. Typically, where threshold values have been set stringently the probability of identical measurement results will be lower, whereas on the other hand if threshold values have been set loosely the probability of identical measurement results will be higher. Of the n-bit digital data obtained through measurement, that part affording identical values even where threshold values have been set stringently (e.g. the first bit through the m-th bit), has a high probability of giving identical values no matter how many times measurements are made. On the other hand, that part not affording identical values despite threshold values having been set loosely (e.g. the (m+a) bit through the n-th bit), has a high probability of giving different values in individual measurements. Accordingly, the biometric information generating unit 160 generates digital data while varying the threshold values, for example. The CPU 110 then analyzes the digital data obtained from the measurement results. As a result, the CPU 110 determines in the n-bit digital data the part thereof affording identical values, and uses the part thereof affording identical values as the biometric information. As a result, the CPU 110 can repeatedly generate identical biometric information for the same given measurement subject. This method of multiple measurements while varying the threshold values allows for biometric information with a greater bit count than does measurement with appropriate threshold values ascertained in advance, so accuracy will be improved. As a result, the likelihood of identical biometric information being generated for different authentication subjects will be lower.

Where the CPU 110 has generated biometric information, the biometric information is saved to the RAM 124 and a biometric information generation confirmation window (not illustrated) is shown on the display 182 (Step S130). A biometric information generation confirmation icon will be displayed in the biometric information generation confirmation window. The CPU 110 waits for the biometric information generation confirmation icon to be selected. Once the CPU 110 detects that the biometric information generation confirmation icon has been selected, the CPU 110 shows a password input screen on the display 182 (Step S135). The password input screen contains a password input field, and a password input icon selected for the purpose of confirming input after entering the password in the password input field, and for initiating the password input process by the CPU 110. This password corresponds to the element of additional information herein. The CPU 110 waits for a password to be input to the password input field, and selection of the password input icon.

Once the CPU 110 detects that a password has been input to the password input field and that the password input icon has been selected, the CPU 110 acquires the password that was entered in the password input field, and saves it to the RAM (Step S140).

The CPU 110 then reads the biometric information and the password from the RAM 124, runs the specific code generation program 136, and generates a unique specific code using the read out biometric information and password (Step S145). The CPU 110 generates a unique specific code using a computational expression such as:

z=a*x+y

where the biometric information is denoted by x, the password by y, and the specific code by z, for example. Here, “a” is a constant. The above computational expression is merely exemplary, the CPU 110 may of course generate specific codes using other computations during generation of the specific codes.

Once the CPU 110 has generated the specific code, the CPU 110 transmits the specific code to the server 200 (Step S150) and waits for the server 200 to reply with notice as to whether an identifying code identical to the transmitted specific code is already registered. If the CPU 110 has not received notice of duplicate specific code from the server 200 (Step S155, N) and has received notice of completion of registration (Step S160, Y), the CPU 110 shows a registration confirmation window (not illustrated) on the display 182. A registration complete confirmation icon is shown in the registration confirmation window. Once the CPU 110 detects that the registration complete confirmation icon has been selected, the CPU 110 terminates the registration process.

If the CPU 110 has received notice of duplicate specific code from the server 200 (Step S155, Y), the CPU 110 displays a duplication confirmation window (not illustrated) on the display 182. The duplication confirmation window contains a Manual Input mode selection icon for selection when it is desired to select a Manual Input mode, and a Select mode selection icon for selection when it is desired to select a Select mode. Here, Manual Input mode refers to a mode in which a user can enter any password when setting up a password, and Select mode refers to a mode in which the user selects one password from among a number of suggested passwords provided by the authentication system when setting up a password. The CPU 110 waits for either the Manual Input mode selection icon or the Select mode selection icon to be selected.

In the event that CPU 110 detects that the Manual Input mode selection icon has been selected (Step S205, N), the CPU 110 returns to Step S135 and displays the password input window on the display 182 (Step S135). Subsequent operation is the same as operation starting from Step S135, thus further explanation is skipped.

In the event that CPU 110 detects that the Select mode selection icon has been selected (Step S205, Y), the CPU 110 generates a password using random numbers, for example (Step S210). The CPU 110 temporarily stores the created password in the RAM 124 (Step S215).

The CPU 110 reads out the biometric information and the password from the RAM 124, executes the specific code generation program 136, and generates a specific code using the read out biometric information and password (Step S220). The CPU 110 then saves the generated specific code in the RAM 124, as well as sending the generated specific code to the server 200 and waiting for a reply with the result of a duplication check as to whether an identifying code identical to the generated specific code has already been registered (Step S225).

In the event of notice from the server 200 that an identifying code identical to the generated specific code is already registered (Step S230, Y), the CPU 110 deletes the generated password and the corresponding specific code from the RAM 124 (Step S235). This is because the password and the specific code in question cannot be used. The CPU 110 then returns to Step S210 and generates a new password.

In the event of notice from the server 200 that an identifying code identical to the specific code sent to the server 200 is not already registered for example, in the event of a specific code non-duplication notice, described later (Step S230, N), the CPU 110 determines whether a prescribed number of passwords are saved in the RAM 124. This prescribed number refers, for example, to the number of suggested passwords for display on a password selection window 400. In the present embodiment, the prescribed number is 4, but could instead be any number equal to 1 one more, and that does not exceed the range of suggested passwords that can be displayed on the password selection window 400. If the prescribed number of passwords have not been saved to the RAM 124 (Step S240, N), the CPU 110 returns to Step S210, executes the subsequent steps, and generates a new password.

If the prescribed number of passwords have been saved to the RAM 124 (Step S240, Y), the CPU 110 displays on the display 182 the password selection window 400 showing the suggested passwords, as shown in FIG. 6 (Step S245).

The password selection window 400 includes radio buttons 402 for selecting one password from among the suggested passwords displayed in the window, a password confirm icon 404 for initiating a process to confirm one of the passwords selected by the authentication system, and a show more suggested passwords icon 406 for showing suggested passwords different from the passwords currently being shown. The radio buttons 402 include four radio buttons 402a to 402d. The CPU 110 then waits for selection of a password or of the show more suggested passwords icon.

If the CPU 110 detects that the show more suggested passwords icon 406 has been selected (Step S250, Y), the CPU 110 deletes the passwords saved in the RAM 124, returns to Step S210, and generates a new password. If the CPU 110 detects that one of the radio buttons 402 has been selected and the password confirm icon 404 has been selected, (Step S250, N), the CPU 110 selects the password corresponding to the selected radio button 402 (Step S255) and delete the other passwords from the RAM 124. By designing password selection in this way, it is possible to prevent passwords from being guessed from movement of the fingers.

The CPU 110 then reads from the RAM 124 the specific code corresponding to the selected password (Step S260), and sends the read out specific code to the server 200 (Step S265). The specific code sent to the server 200 at this time has already undergone a duplication check in the server 200 and has been verified to not match any identifying codes already registered. Consequently, it will be immediately registered in the server 200.

Once the specific code has been registered in the server 200, notice of completed registration is sent from the server 200. Upon receiving notice of completed registration (Step S270), the CPU 110 displays a registration confirmation window (not shown) on the display 182. A registration complete confirmation icon is displayed in the registration confirmation window. When the CPU 110 detects that the registration complete confirmation icon has been selected, the CPU 110 terminates the registration procedure.

If the CPU 110 detects that a registration correction icon has been selected (Step S105, N), the CPU 110 displays on the display 182 an account input window (not shown) for the purpose of inputting account information. In the account input window there is displayed an account input field, an input icon for confirming the input account and instructing the CPU 110 to execute the next process, and a checkbox which can be checked to either to continue to use the identifying data already registered in the server 200 or to update the registered identifying data with new identifying data.

If the CPU 110 detects that an account has been entered in the account input field of the account input window and that the input icon has been selected, the CPU 110 acquires the content entered in the account input field of the account input window and send the entered contents to the server 200 as account information. At this time, information indicating whether the checkbox has been checked is also sent to the server 200. The checkbox is provided for the purpose of instructing the server whether to continue to use the identifying data already registered in the server or to update it with new identifying data. In the present embodiment, if the checkbox has been checked, the identifying data is updated with new data, and an identifying code delete notice is sent from the server 200 to the terminal device 100. If on the other hand the checkbox has not been checked, the identifying code is sent from the server 200 to the terminal device 100.

In the event that the CPU 110 has received an identifying code deletion notice (Step S310, Y), the CPU 110 skips to Step S120 and subsequently executes an operation similar to that during new account registration, then transmits the generated specific code to the server 200 and register the generated specific code as the new identifying code.

In the event that the CPU 110 has received an identifying code but has not received an identifying code deletion notice (Step S310, N), the CPU 110 saves the received identifying code to the RAM 124. The CPU 110 then generates biometric information (Step S320 to Step S330). The operation from Step S320 to Step S330 is similar to the operation from Step S120 to Step S130, thus further explanation is skipped.

Once the CPU 110 has generated the biometric information, the CPU 110 generates a password (Step S335). The CPU 110 reads the biometric information and the identifying code from the RAM 124, and uses the biometric information and the identifying code to generate the password. This is accomplished by a computation that is the reverse of the computation for generating the specific code from the biometric information and the password. For example, where the computation for deriving the specific code z is z=a*x+y as discussed previously, it will be simple matter to derive the password y by performing the reverse computation. Here, the generated password is a unique one.

Once the CPU 110 has generated the password, the CPU 110 displays a password confirmation window on the display 182, for the purpose of confirming the generated password (Step S340). A password confirmation icon is displayed in the password confirmation window. When the CPU 110 detects that the password confirmation icon has been selected, the CPU 110 terminates correction of account registration content. The user may be prompted to enter the password when selecting the password confirmation icon.

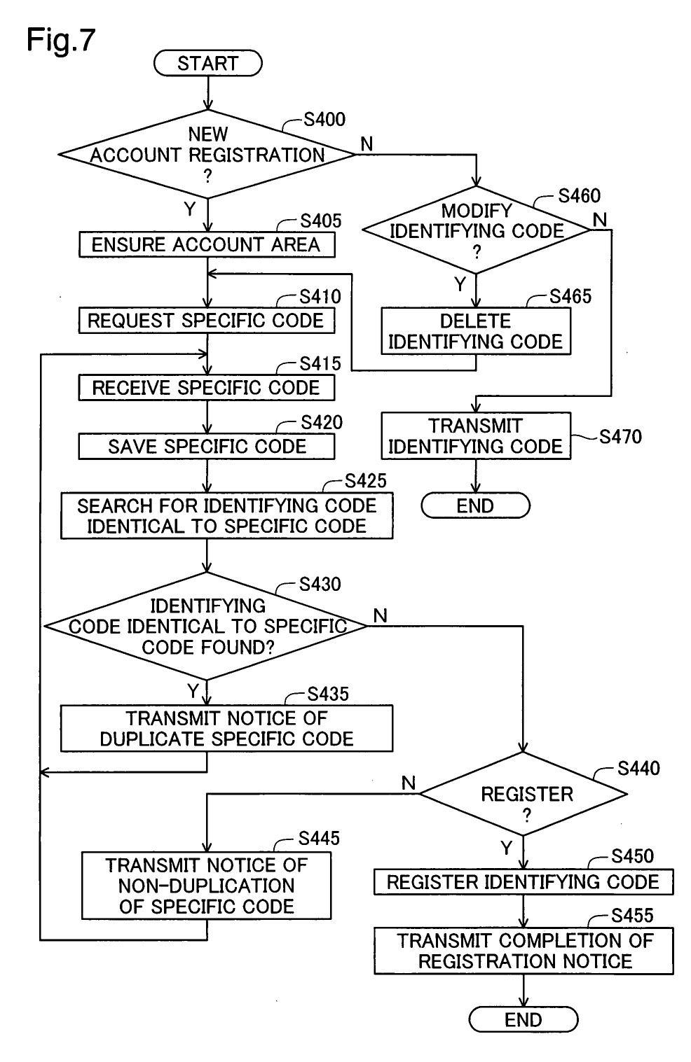

Operations of the server 200 during registration of the authentication system 10 will now be described with reference to FIG. 7. FIG. 7 shoes a flowchart depicting operation of the server 200 during registration.

In the event that account registration or correction of registration content is to be carried out on the authentication system 10, the CPU 210 of the server 200 receives from the terminal device 100 an instruction indicating whether to register a new account or correct an existing account.

If the CPU 210 detects that the received instruction is a new account registration (Step S400, Y), the CPU 210 creates and determines an account number, and ensure an account area on the hard disk drive 230 (Step S405). The account area is an area for storage of data relating to the account. The CPU 210 saves the account number on the RAM 224.

The CPU 210 then requests the terminal device 100 for the specific code (Step S410). The CPU 210 then receives the specific code from the terminal device 100 (Step S415), and saves the specific code in the RAM 224 (Step S420). The CPU 210 then reads out the specific code from the RAM 224 and performs a search of the database file 236 to determine if an identifying code identical to the specific code is already registered (Step S425). Typically, results acquired through biometric measurement will not be completely identical, for example, in the case of fingerprint authentication, due to differences in the angle of rest of the finger on the measuring portion or the level of force with which the finger is pressed against the measuring portion. Consequently, where measurement results per se are compared with registered data, the CPU need to decide as to the degree of similarity between the measurement results and the registered data, and this crosscheck takes some time. In the present embodiment, however, it suffices to check whether the specific code and the identifying code match, so the search can be completed within a short time.

If the CPU 210 detects that an identifying code identical to the specific code is already registered in the database file 236 (Step S430, Y), the CPU 210 transmits notice of specific code duplication to the terminal device 100 (Step S435). If an identifying code identical to the specific code is not already registered in the database file 236, the CPU 210 decides whether to register the specific code (Step S440). For example, where the specific code has been sent by Step S225 shown in FIG. 4, the CPU 210 does not register the specific code. In the event that the CPU 210 does not register the specific code (Step S440, N), the CPU 210 transmits notice of specific code non-duplication to the terminal device 100 (Step S445).

In the event that the CPU 210 decides to register the specific code (Step S440, Y) the CPU 210 registers the account number in the database file 236, and register the specific code as the identifying code (Step S450). Once the CPU 210 has completed registration of the account number and the identifying code, the CPU 210 transmits notice of completed registration to the terminal device 100 (Step S455).

If the CPU 210 has detected that the received instruction is an account registration correction (Step S400, N), the CPU 210 decides whether to modify the identifying code (Step S460). If the CPU 210 has found in the received account information that indicates a change of the identifying code (Step S460, Y), the CPU 210 deletes the identifying code from the database file 236 (Step S465). The CPU 210 then skips to Step S410, and subsequently carries out an operation similar to that of new account registration. In the event that registration content is to be corrected, in Step S450, since the account number has already been registered in the database file 236, the account number will not be registered during registration of the identifying code.

In the event that the CPU 210 could not find in the received instruction information that indicates a change of the identifying code (Step S460, N), the CPU 210 transmits the identifying code to the terminal device 100.

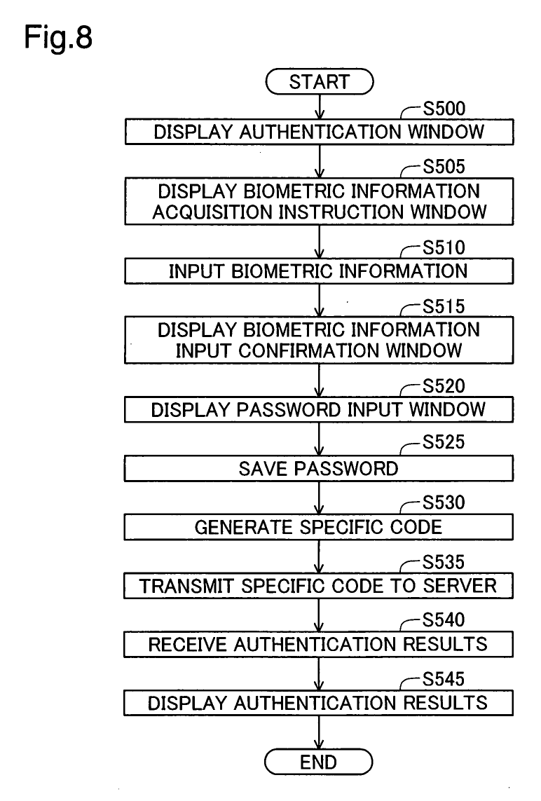

The operations of the terminal device 100 during authentication will now be described with reference to FIG. 8. FIG. 8 is a flowchart depicting operation of the terminal device 100 during authentication.

During authentication, in order to indicate the fact that it is operating in authentication mode, the CPU 110 displays an authentication window (not illustrated) on the display 182 (Step S500). An authentication icon is shown in the authentication screen. If the CPU 110 confirms that the authentication icon has been selected, the CPU 110 then displays a biometric information acquisition instruction window (not shown) for instructing measurement of biometric information (Step S505).

The CPU 110 acquires the biometric information and sends a specific code to the server (Step S505 to Step S535). Operation from Step S505 to Step S535 is the same as operation from Step S120 to Step S150 during registration, thus further explanation is skipped.

Once the CPU 110 receives an authentication result from the server 200 (Step S540), the CPU 110 displays an authentication result display window on the display 182 (Step S545). A confirmation icon is displayed in the authentication result display window. When the CPU 110 confirms that the confirmation icon has been selected, the CPU 110 enables access by the user, for example. If authentication was not successful, the authentication result display window (not illustrated) will be displayed on the display 182 (Step S545). A confirmation icon is displayed in the authentication result display window. When the CPU 110 confirms that the confirmation icon has been selected, the CPU 110 executes the next authentication. Even if it is not confirmed that the confirmation icon has been selected, the next authentication will be executed after a prescribed time interval has elapsed. This is because in the event of failure to confirm, the confirmation icon will not necessarily have been selected.

According to the embodiment described hereinabove, since the CPU 110 analyzes measurement results measured by the biometric information generating portion, and using the part thereof that does not fluctuate as biometric information, generates a unique specific code together with additional information; and the CPU 210 decides whether the specific code matches a registered identifying code, the search can be completed within a short time. Accordingly, the authentication system is capable of authentication within a short time.

According to the present embodiment, measurements are made multiple times while varying the threshold value, when generating biometric information. As a result, by analyzing the results of measurements made multiple times, identical biometric information can be reproduced through the use of values of the part that does not fluctuate across individual measurements.

According to the present embodiment, since biometric information is generated using the non-fluctuating portion of the measurement results, there may be instances in which, by chance, biometric information is identical for different individuals. Accordingly, the CPU 110 generates specific codes from a combination of biometric information and additional information. When registering a specific code generated by the CPU 110, the CPU 210 checks whether the specific code matches a previously registered identifying code, and if there is a match, instructs that different additional information be entered. Consequently, in no instance will a specific code identical to a previously registered identifying code be registered, and each registered specific code will be unique.

According to the present embodiment, in the event that different additional information is input, there will be displayed suggested passwords for the purpose of avoiding generation of a specific code identical to identifying codes registered from the authentication system, so the user need simply select a desired password for use, from among the suggested passwords. By employing this password selection format, it is possible to reduce the risk of the password being stolen through observation of movement of the fingers when the password is entered, for example.

### Modification Examples:

In the present embodiment, the password is entered from a keyboard, but it would be possible, for example, to instead provided a second biometric information for generating biometric information different from the generated biometric information, and use the second biometric information as a password. This is because it is essentially impossible for biometric information of different individuals to further match in terms of the second biometric information as well. A device identical to that of the biometric information generating portion may be used for the second biometric information generating portion as well. For example, if the biometric information is information generated from a fingerprint, biometric information generated from a different finger may be used as the second biometric information.

In the present embodiment, the biometric information is generated using digital data, and non-reversible data conversion may be carried out at this time. The digital data representing the measurement results can be hidden.

In the present embodiment, suggested passwords are generated by the terminal device 100, but could instead by generated by the server 200. Communication traffic can be reduced thereby, since there will be no communication from the terminal device 100 to the server 200 for the purpose of the specific code duplication check.

In the present embodiment, fingerprint authentication was described by way of example of biometric authentication; however, it would be possible to use other forms of biometric authentication, for example, the shape of the palm, the retinal blood vessel pattern, or the like.

In the present embodiment, identifying codes and accounts are associated on a one-to-one basis, but it would be acceptable to instead associate several identifying codes with a single account. For example, where an authentication system is being used in a financial system, it would be possible to configure the system so that a single corporate account can be accessed by several accounting employees.

While the present embodiment describes an authentication system composed of a terminal device and a server device, the present invention may of course be embodied in a single-unit authentication device not divided into a terminal device and a server. Nor is the invention limited to embodiment in an authentication system or authentication device, and may also be embodied as an authentication method or registration method.

The foregoing description of the present invention based on certain preferred embodiments is intended to aid in understanding of the invention and not for the purpose of limiting the invention. Various modifications and improvements to the invention may be made without departing from the spirit and scope of the invention as set forth in the appended claims, and these shall be included among equivalents of the invention.

What is claimed is:

1. An authentication system comprising a terminal device and a server, wherein
the terminal device comprises:
a biometric information generating unit configured to acquire biometric characteristics and generates biometric information;
an additional information input module for inputting additional information;
a specific code generating module configured to generate a specific code unique to each combination of the biometric information and the additional information using the biometric information and the additional information; and
a communication module configured to send the specific code to the server;
the server comprises:
a communication module configured to receive the specific code;
a storage that associates and stores an identifying code and an account;
a search module configured to search for an identifying code matching the specific code; and
an account specifying module configured to specify an account matching the identifying code retrieved by the search module.

2. The authentication system according to claim 1 wherein
the specific code generating module generates a specific code using biometric information having identical values, when the biometric information generating unit has measured the same measurement subject.

3. The authentication system according to claim 2 wherein
the biometric information generating unit measures the same measurement subject multiple times, and generates biometric information using a part of measurement results having identical values from among the measurement results.

4. The authentication system according to claim 3 wherein the biometric information generating unit measures a measurement subject multiple times while varying the conditions of measurement.

5. The authentication system according to claim 4 wherein the biometric information includes data having undergone irreversible data conversion.

6. The authentication system according to claim 5 wherein
the server further comprises
an identifying code registering module configured to register the generated specific code as an identifying code.

7. The authentication system according to claim 6 wherein
the server further comprises
an input instructing module configured to instruct the terminal device to input different additional information, in the event that, during registration of an identifying code in an authentication device, an identifying code identical to the generated specific code is already stored in the storage.

8. The authentication system according to claim 7 further comprising
a suggested additional information generating module configured to generate suggested additional information for use by the specific code generating module to generate a specific code different from the already registered identifying code.

9. The authentication system according to claim 8 wherein
the suggested additional information module is provided to the terminal device.

10. The authentication system according to claim 8 wherein
the suggested additional information module is provided to the server.

11. The authentication system according to claim 1 wherein
the terminal device further comprises
a second biometric information generating unit configured to generate second biometric information for use as additional information, from biometric characteristics different from the aforementioned biometric characteristics.

12. The authentication system according to claim 1 further comprising
an additional information generating module configured to generate additional information for use by the specific code generating module to generate a specific code that matches the already registered identifying code, in the event that the identifying code has already been registered for a given account.

13. The authentication system according to claim 12 wherein
the additional information generating module is provided to the terminal device.

14. The authentication system according to claim 1 wherein
the storage stores multiple identifying codes in association with a single account.

15. An authentication device comprising:
a biometric information generating unit configured to acquire biometric characteristics and generate biometric information;
an additional information input module for inputting additional information;
a specific code generating module configured to generate a specific code unique to each combination of the biometric information and the additional information using the biometric information and the additional information;
a storage that associates and stores an identifying code and an account;
a search module configured to search for identifying code matching the specific code; and
an account specifying module configured to specify an account matching the identifying code retrieved by the search module.

16. A method of registering to an authentication system, comprising:
taking multiple measurements of a measurement subject and acquiring biometric information;
generating biometric information using some of that portion of measurement results having identical values from among the measurement results;
generating a unique first specific code using the biometric information and inputting additional information;
searching for an identifying code matching the specific code, from a storage storing in associated form an identifying code and account;
in the event that an identifying code matching the first specific code has not yet been recorded in the storage, registering the first specific code as an identifying code;
in the event that an identifying code matching the specific code has already been recorded in the storage, generating suggested additional information for generating a specific code that does not match the identifying code already registered in association with the biometric information;
generating a unique second specific code using the additional information and the biometric information; and
registering the second specific code as an identifying code.

17. An authentication method in an authentication system, comprising:
taking multiple measurements of a measurement subject and acquiring biometric information;
generating biometric information using some of that portion of measurement results having identical values from among the measurement results;
generating a unique first specific code using the biometric information and input additional information;
searching for an identifying code matching the specific code, from a storage storing in associated form an identifying code and account; and
in the event that an identifying code matching the specific code is found, identifying the account associated with the identifying code.
